(19) United States
(12) Patent Application Publication
(10) Pub. No.: US 2016/0247494 A1
(43) Pub. Date: Aug. 25, 2016

(54) METHOD OF DISPLAYING MUSICAL SCORE

(71) Applicant: Orlay Alonso, New Albany, OH (US)

(72) Inventor: Orlay Alonso, New Albany, OH (US)

(21) Appl. No.: 15/013,686

(22) Filed: Feb. 2, 2016

Related U.S. Application Data
(60) Provisional application No. 62/110,963, filed on Feb. 2, 2015.

(51) Int. Cl. G10G 1/00

(52) U.S. Cl. CPC G10G 1/00; G10H 2220/015

(57) ABSTRACT

A method of displaying a musical score by identifying segments or blocks of material and organizing them linearly on a display template. Also described is the visual layout of the musical score after being arranged in blocks.

### CROSS-REFERENCE TO RELATED APPLICATION

This application claims the benefit of and priority to prior filed pending U.S. Provisional Application Ser. No. 62/110,963, filed Feb. 2, 2015, which is expressly incorporated herein by reference.

### TECHNICAL FIELD

The present invention provides a method of displaying a musical composition that offers an immediate representation of the overall formal design of the composition (also referred to as formal structure, form, structure, architectural design) from the first moment one lays eyes on the score. It is a symbolic representation of music that has been organized in a coherent phrase structure by reconstructing the score into musical blocks (musical phrases, musical sentences), not limited by traditional printing parameters and page measurements.

This method addresses the complexity of grasping the relationships among formal structure, thematic representation, temporal dimension, harmonic and melodic hierarchy, and how they function in a musical context.

### BACKGROUND

Music has been published in “prose” for over five hundred years, produced with the economy of space in mind from a printing perspective. In other words, musical prose signifies that the traditional organization of a score is one long, continuous succession of bar lines that has been laid out to best fit the page, without regard to the musical content, where one measure follows another in a linear fashion. In reviewing a musical score presented in this way, pattern recognition becomes very challenging.

The “traditional” score layout is the most commonly used approach in presenting music. However, it does not allow for an intuitive musical perception of poetic verse, it lends no academic insight into the analysis of music to the untrained eye, and it does not highlight the relevance of the musical material.

### SUMMARY OF THE INVENTION

The invention is directed to organizing segments of a musical composition or score, such that the segments are formed into blocks and the blocks are then arranged in order on a display template. This display template may be a page onto which the blocks are printed, or the template may be an electronic display device such as a computer screen or other display driven by a processor. Alternately, the display template may be a medium onto which the blocks are permanently or reversibly displayed.

After following the procedures of the new poetic approach herein described, one discovers that the mathematical proportions that appear can not only show but also corroborate the architectural design of any given composition. Furthermore, the invention highlights the idea of intelligent phrasing, which requires taking into account the different factors that affect a musical phrase, such as melodic contour, harmonic hierarchy, dissonance treatment, points of rest and tension for a complete phrase, among others that come to light as a result of the procedures of the method.

The invention may be designed as analytical performance editions, for performing artists and educators, that incorporate semiotic tools into the study of musical language intended to make the architectural design of a score visible in a logical format. From a pedagogical point of view, this facilitates the learning process thus yielding a significant impact on music education and performance.

Once one (performing artists, educators, composers, musicologists and all who read music) can understand how the content of a composition is organized through its architectural design, mathematical concepts, proportions, phrase structure, spatial relations, temporal proportions, etc. in the visual perspective herein proposed, one can attain a deeper appreciation and understanding of the process of composition, the meaning of music and its form and thus as a performer execute an informal rendition of any given score.

The present invention can provide:
A new analytical edition for performers, teachers, and students that gives a comprehensive overview of the score displaying a work in its entirety containing an organized set of phrases (blocks).
A graphically logical representation of the mathematical proportions that occur intentionally or inadvertently when a musical work is composed.
A poetic “verse-like” analysis applied to any piece of music that will visually represent the architectural design of the composition.
A unique visual representation of the musical content and form that visually delineates musical fragments herein by color. Those visual findings may then be overlaid on the method herein to allow the user to be able to examine the various views of the findings in order to decipher the meaning of the composition and thus reveal the composer's intent. In other words, once the music is organized in phrases, one can freely move any block (phrase) anywhere on the score in order to allow for a side-by-side comparison.
The visual layout of the score differs from a traditional printed score. Instead of effectively being one long continuous line that has been laid out to best fit the page, not the musical material, and subsequently with no ongoing relevance to the music material, the view provided by the present invention can restructure the material together into blocks and provide a more practical system for learning and appreciating the score.

Embodiments of the invention can be implemented as a new platform that provides the user access to the most up-to-date comprehensive understanding of musical form and structure. It can overlay graphical reductions of pertinent structural designs such as phrase lengths, melodic relationships, harmonic structure, and rhythmic patterns, for example. In other words, each system will consist of complete phrases, which at one point or another will create discrepancies in the number of measures in a system which will further assist in understanding the score. It can also incorporate the traditional theoretical practices of harmony and voice leading, the analysis of tonal and atonal music and the elements of form and meter in a holistic approach.

Displaying a score according to embodiments of the invention can allow the user to compare and interpret the music from different analytical points of view such as harmonic, melodic, rhythmic, and formal, from the very detailed to the general. The visual layout of a score plays a significant role in any person's assimilation of the musical content. Thus, embodiments of the present invention will aid in visual memory, pattern recognition, sight-reading and performance in general. From a pedagogical perspective, performers and educators can utilize a new set of tools to raise the baseline of the learning process in music.

Once a piece of written music has been processed by embodiments of the method of the present invention, the associated visual representations by categories are combined to create an interactive score (digital edition, software, interactive PDF, etc). The score then can become a comprehensive compilation of graphical, written and visual data that the user can seamlessly toggle through while learning any composition.

The process can be laid out in a format similar to poetic verse which can allow the user to gain greater understanding of the score and its meaning. One can perform a more meaningful and faithful rendition of the music by shaping musical phrases more intelligently. The herein described poetic approach shows an organized representation of patterns that exist in music rather than a long continuous line that has been laid out to best fit the page from a printing perspective.

The method of embodiments of the present invention restructures the material in a new layout into blocks of phrases regardless of the length of measures. This provides a more practical system for learning the score. In addition, color can be implemented more extensively in the scores according to this embodiment and may require an editing program that can add color to any and all parts of the score, such as the note heads, note stems, note beams, clefs, systems, time signatures, phrasings, dynamics etc. at any point in the score. The resulting scores can be displayed on electronic devices in standard format such as PDF, single PDF interactive, Jpeg, image, editable XML, and Mus format, for example, and will continue to adapt to the new formats that becomes available in the future.

The graphical display of the score's inherent architectural structure aids in the demonstration of how compositional space is proportionally divided by the composer. It then presents a concrete graphical analysis of how the composer utilized that space. The visual demonstration of such ubiquitous concepts that are often based on one's own fundamental understanding of musical form and analysis remains a deficit in most modern editions that are currently available. The invention aims to bridge the gap between the current offerings of “scholarly” or “performance” editions.

### BRIEF DESCRIPTION OF THE FIGURES

This patent or application file contains at least one drawing executed in color. Copies of this patent or patent application publication with color drawing(s) will be provided by the Office upon request and payment of the necessary fee.

FIG. 1 shows a poem by Emily Dickinson illustrated by stanza, verse, and syllable;

FIG. 2 shows Fugue No. 2 in C minor by J. S. Bach displayed in a score according to a method of the present invention;

FIG. 3 shows various parameters of the score illustrated according to a method of the present invention;

FIG. 4 shows other parameters of the score;

FIG. 5 shows a Mersenne Prime Number sequence and prime numbers up to 31;

FIG. 6 is a chart showing the geometric sequence and series of the Mersenne Prime Numbers from FIG. 5;

FIGS. 7 and 8 show the mathematical relationships from the Bach Fugue;

FIGS. 9 and 10 show a color orchestration and poetic form according to a method of the present invention;

FIG. 11 shows another version of the score according to a method of the present invention;

FIG. 12 shows a counter subject of the work in a score according to a method of the present invention;

FIG. 13 shows an analysis of the episodic material separately;

FIG. 14 illustrates the Architectural Design of the score (turned on its side) according to a method of the present invention;

FIGS. 15 and 15a show a comparison of episodes two and three;

FIG. 16 shows a score of Schoenberg's Piano Suite op. 25, Prelude, displayed according to a method of the present invention;

FIGS. 17 and 17a-17f show the matrix for the entire Schoenberg suite, used as the base mathematical structure;

FIG. 18 shows three groups or sections made up of eight bar phrases illustrating the form and architectural design of this prelude;

FIG. 19 illustrates how rhythm takes precedence over melody in this example;

FIG. 20 shows a second example from the Schoenberg Suite;

FIGS. 21-23 show three overlapping palindromes in measure 13 of the Schoenberg Suite in detail;

FIG. 24 shows in detail the three overlapping palindromes of measure 13;

FIG. 25 shows the re-exposition of section three of the work;

FIGS. 26-29 show a new mathematical basic principle of construction in which four trichords of the Set are proportionally built using a Clock Wheel;

FIG. 30 shows a score of Mozart's Piano Sonata No. 4 in E-flat major, K. 282. III, according to an embodiment of the present invention;

FIG. 31 shows a seven measure phrase (the transition) in the exposition;

FIG. 32 shows a mathematical proportion that clarifies the division of themes and phrases; and

FIG. 33 illustrates aspects of the Golden Ratio.

FIG. 34 is a block diagram of a computer system in accordance with embodiments of the invention.

### DETAILED DESCRIPTION OF THE INVENTION

In its broader aspects, the invention is directed to a method of organizing segments of a musical composition comprising identifying more than one block of material within the musical composition presenting each block in a linear fashion on a display template, with each such presented block located in a distinct space on the display template, and organizing the presented blocks on the display template in a reproducible order.

It is also directed to a visual layout of a musical score comprising more than one block of material selected for the musical score, each block arranged on a display template in a linear fashion in a distinct space on the display template.

More specifically, herein is also explained and illustrated a new publishing format containing the analysis of examples of works by Bach, Mozart and Schoenberg as explained and illustrated herein. In addition, diagrams and color-coding illustrate how mathematics and music are combined to explain the concept of balance in musical form from analysis of features of a composition after organization of its segments, thereby revealing the inherent beauty of a composer's cohesive thought process.

Below is a transcription of a poem by Emily Dickinson in the layout of prose rather than verse in order to show a parallel comparison of what the author hopes to accomplish musically:
“I have no life but this, to lead it here; nor any death, but lest dispelled from there; nor tie to earths to come, nor action new, except through this extent, the realm of you.”—Emily Dickinson

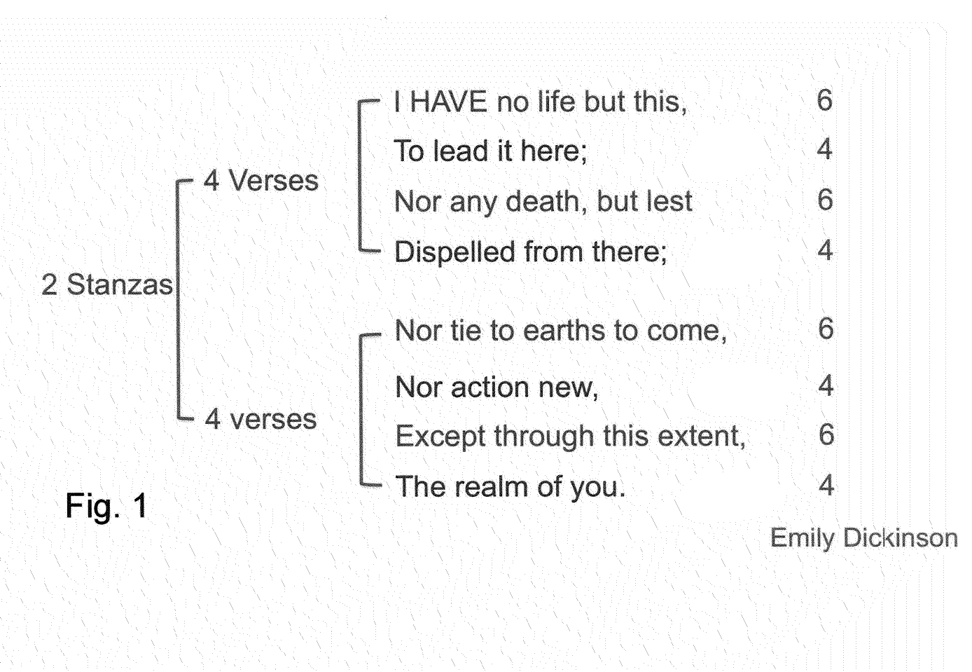

Immediately, one can deduce that it is very difficult to analyze a poem in prose. Such format is not very helpful to the reader in the poetic delivery of the work. The advantages of looking at the poem in its rightful shape or originally intended design can be examined in FIG. 1. One can clearly see the intended “Architectural Design” which consists of one poem made up of two stanzas with four verses per stanza, where the words having the color green represents rhyme as in a Ballad, alternating six and four syllables per verse.

After analyzing the poem in both formats, one can begin to realize that music has been published in “prose” for hundreds of years, written with the economy of space in mind from a printing perspective. It is the 21^{st} Century and one no longer needs to worry about what the size of the score is, and in this digital era sheet music is more likely to be in a virtual score format.

Embodiments of the method of the invention provide a new platform or score layout that portrays the formal structure of any given musical composition in a format similar to that of poetic verse, rather than that of continuous prose, where one measure follows another in no relevant way. Phrase lengths, melodic relationships, harmonic structure, and rhythmic patterns will play a significant role in the overall visual layout of the work, and will vary with the composition. In other words, each system will consist of complete phrases, which at one point or another will create discrepancies in the number of measures in a system. The motivation for the creation of such editions grew out of the need to enable performers and educators to experience an immediate representation of the overall formal design of a musical composition in order to attain a deeper understanding of the meaning of music and form, from the first moment one lays eyes on the score.

Phrase lengths, melodic relationships, harmonic structure and rhythmic patterns will play a significant role in the overall visual layout of the.

The method works by organizing the musical content on the page in complete thoughts or phrases. The page layout works as a visual representation of the method's parameters. Once music is organized in a coherent phrase structure, the form reveals itself. It is believed that this new perspective will impact the ways one learns and teaches formal structure in music.

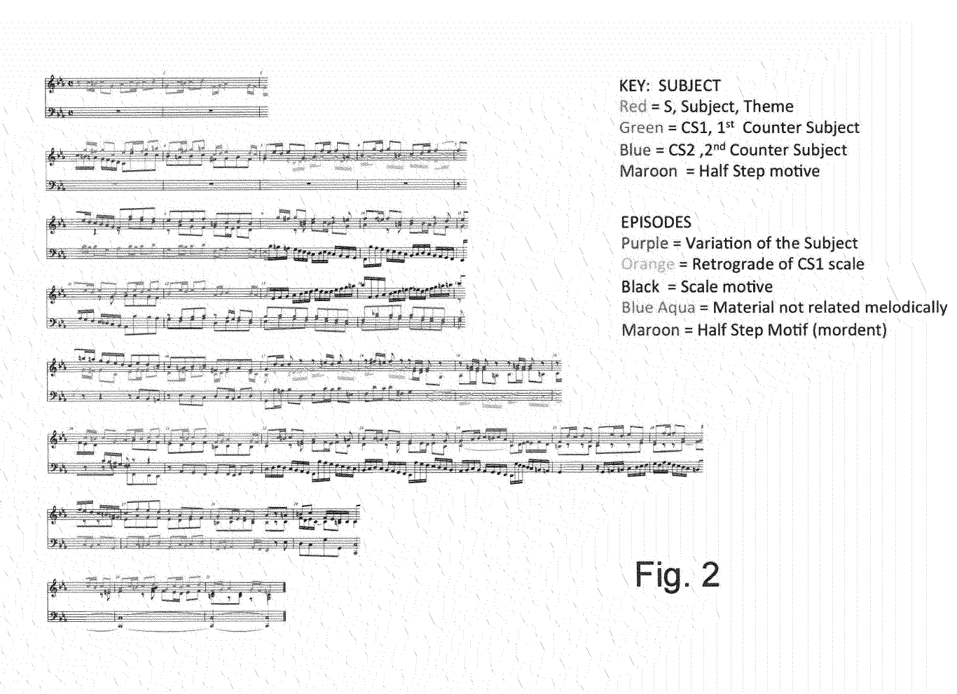

FIG. 2 shows an example score layout of a well-known fugue by J. S. Bach (Fugue No. 2 in C minor, BWV 847) which includes organizing the score on the page in complete musical thoughts commonly referred to as phrases.

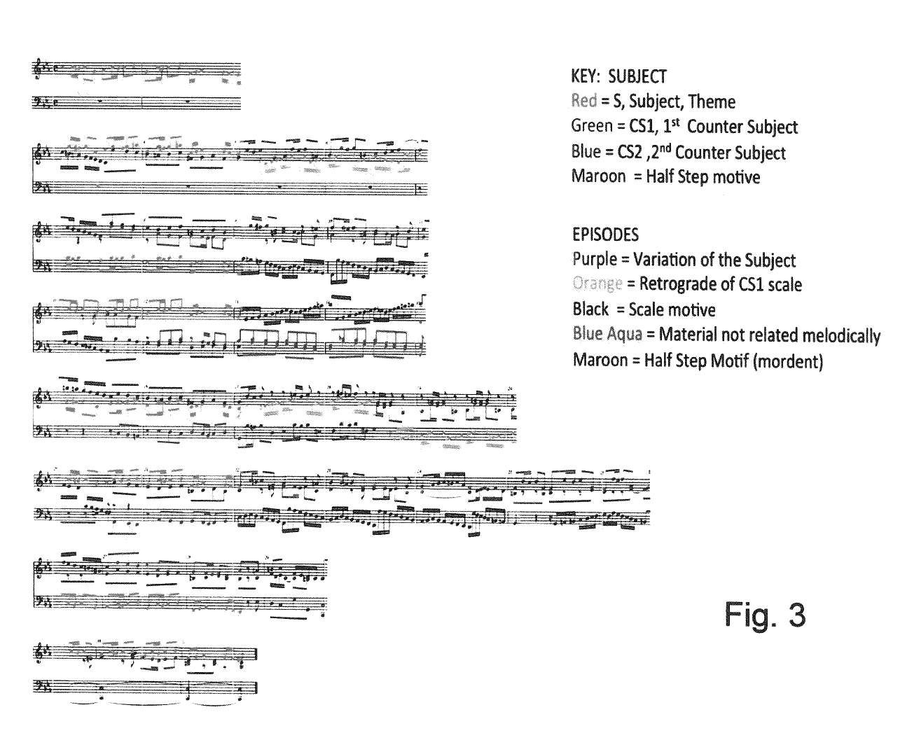

As illustrated in FIG. 3, parameters of the method may include one or more of the following:
All measures are equally divided through space (keeping in mind that music is an architectural structure that takes place through time and is audible only through time).
All measures are displayed of equal length from bar line to bar line in the same time signature (notice that the lines are perfectly aligned and equidistant in FIG. 3).
All notes should be notated with an even beat spacing (must correspond with the time it takes to play).
All bar lines should create a straight line down the page as to create a perfect uniform visual experience.
The number of measures in a system is determined by the length of the phrase.
Measure numbers may be displayed on every measure and the last measure in the system is highlighted with color in order to show mathematical proportions.
Phrase lengths can be notated as they are, regardless of where they fall within the bar lines, and should be written as though the bar lines don't exist.
Phrases are self-contained (left justified).
Phrases follow the rules of harmonic and formal structure intended by the composer (sentence structure, fugal, binary, ternary, poetic, etc.).
The entire composition may be color-coded at the melodic, harmonic, rhythmic, formal and fragment level.
Color-coding can highlight the desired analytical aspect of the work.
Colors connect similar or equal melodic, harmonic or rhythmic material.
All concepts of form and structure are labeled on the score, i.e. exposition, development, subject, counter subject, row, set, retrograde, etc.

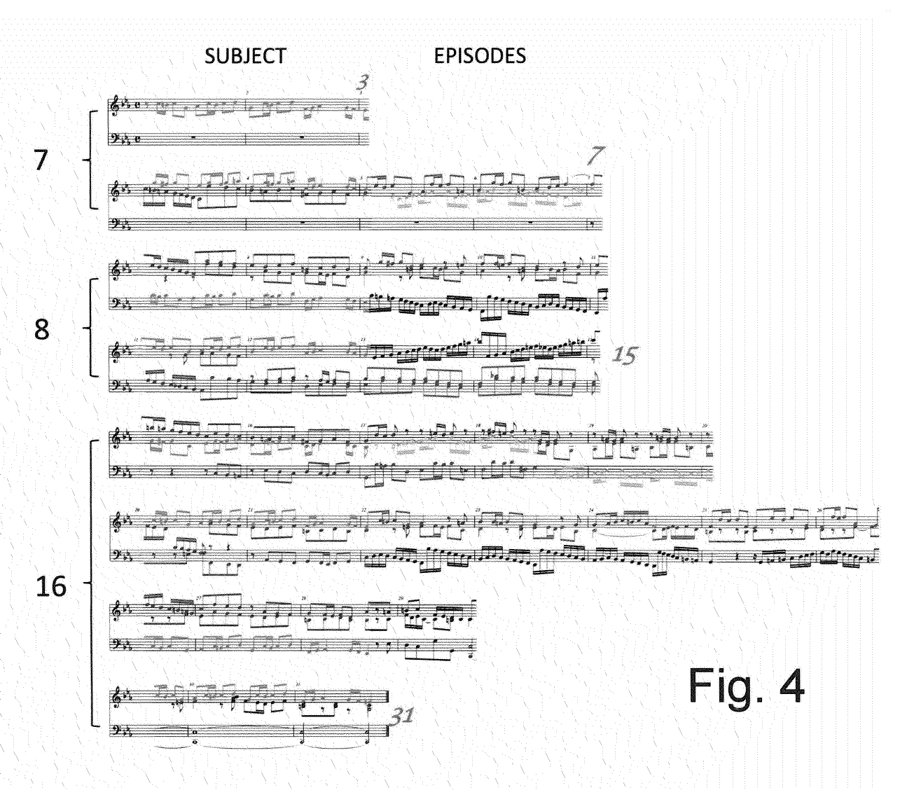

After following the procedures of this new approach, one begins to notice that mathematical proportions come to light. Referring to FIG. 4, on the left side of the score in black are the mathematical proportions and on the right side in red the measure numbers that book end each phrase. The work is 31 measures long with proportions of 8 and 16 (doubling in size) and proportions of 3, 7, 15 and 31 in red. Could Bach have based the formal architectural structure of this fugue on the Mersenne numbers? FIG. 4 illustrates an example.

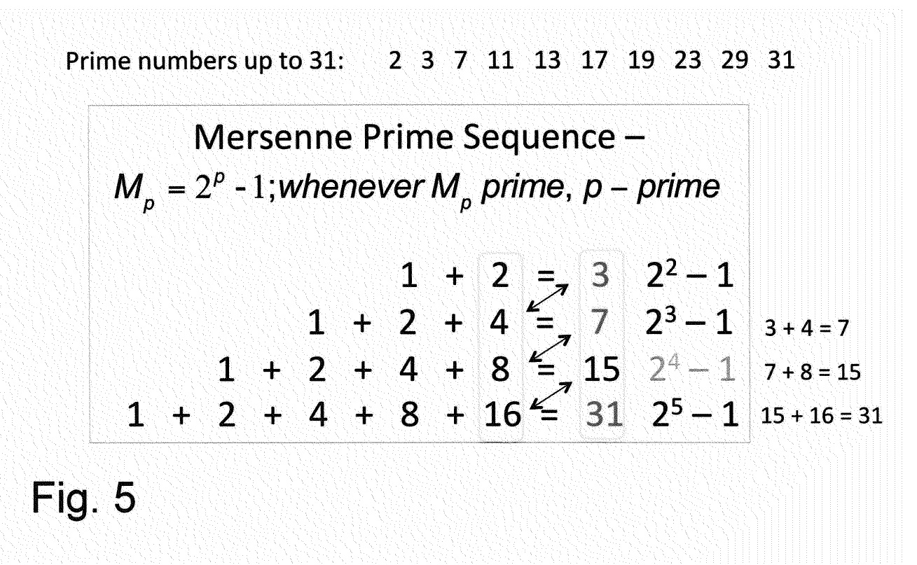

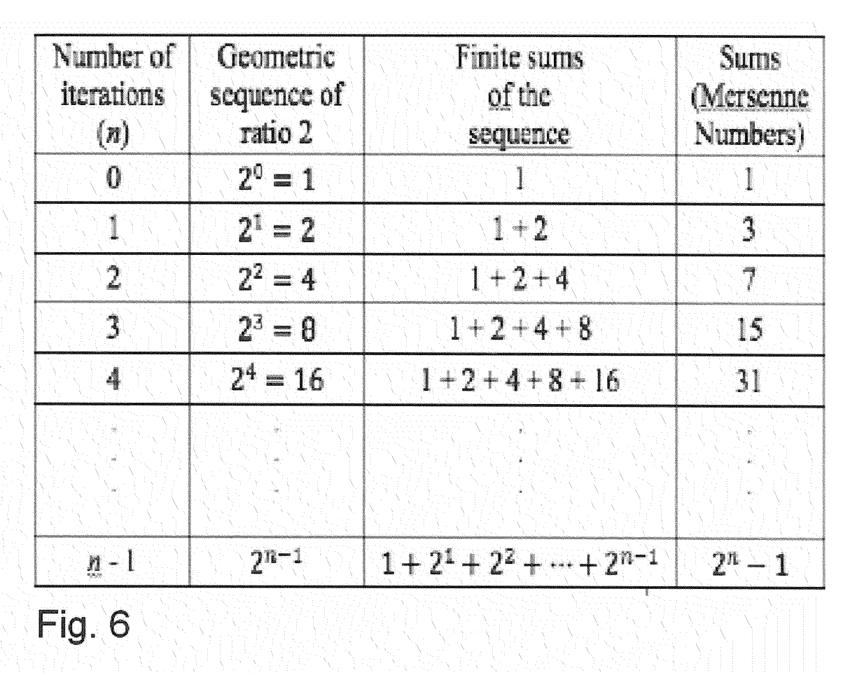

Referring now to FIGS. 5 and 6, while looking at the mathematical aspects of form in this work in more detail, the Mersenne primes are shown in red. Note that even though 15 is not a prime number it is nonetheless an integral part of the Mersenne numbers' sequence.

As used herein:

Mersenne Numbers are numbers of the form: Mₚ=2^{p}−1, n≧0.

A geometric sequence is a sequence where the quotient of two consecutive terms is a constant, which is called the ratio of the geometric sequence.

A geometric series is a series (sequence of sums) whose terms (addends) form a geometric sequence.

A Mersenne number is a term of the geometric series of ratio 2.

A prime number (building blocks of numbers) is a number greater than 1 that is divisible only by 1 and by itself.

The prime numbers up to 31 are: 2 3 7 11 13 17 19 23 29 31.

A Mersenne prime is Mersenne number which is a prime number.

The first four Mersenne primes are 3, 7, 31 and 127.

It is not only plausible but appropriate to correlate the work of Bach with Mersenne, based on this fugue's proportions and on the observation that not only was Mersenne a mathematician, instrument builder and theorist but his contributions to equal-temperament tuning could tie him directly to Bach's Well-Tempered Clavier.

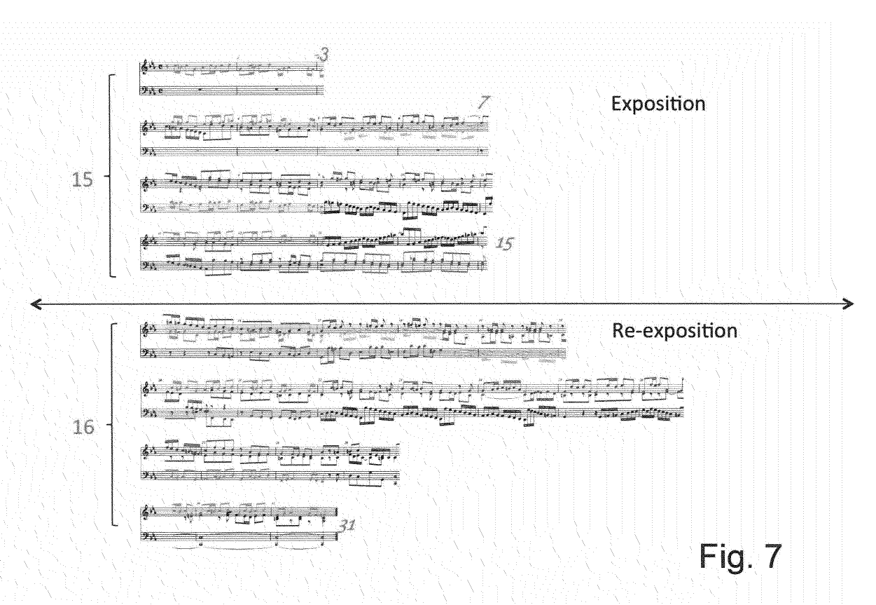

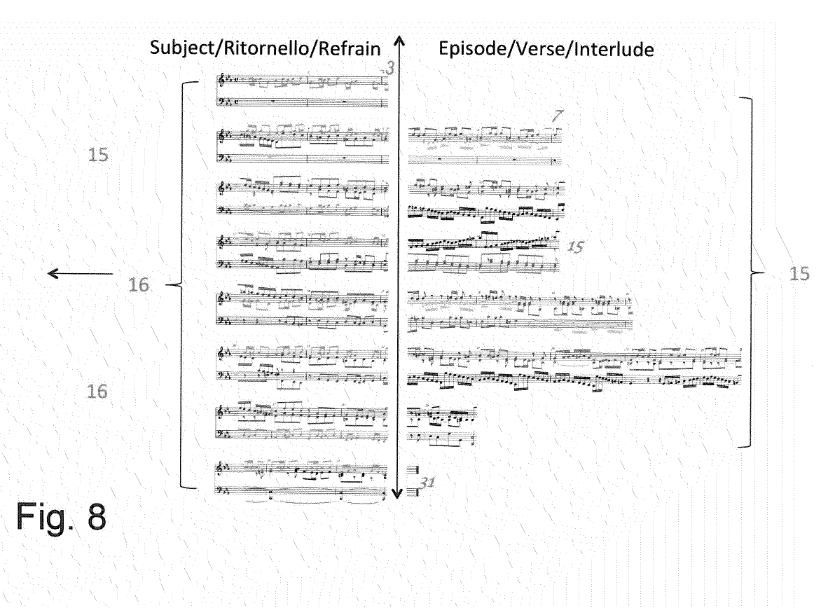

After having reviewed the mathematical terminology one can apply such knowledge to the score. When one “formally” divides the fugue in sections horizontally, into exposition and re-exposition (see FIG. 7), one notices that the exposition is 15 measures long and the re-exposition is 16 measures long. The exposition and re-exposition comprise groups of phrases, or groups of blocks as used herein. Mathematically speaking one would be more satisfied with an equal division of 16 and 16, adding up to the enjoyable 32 which in music is so favored and easily remembered due to the subdivision of rhythm into whole, half, quarter, eighth, sixteenth, thirty-second, etc. Now the mastery of Bach's mathematical knowledge is represented in the connection between the examples shown in FIGS. 7 and 8.

The beauty of the layout lies in the reciprocity of form; it works horizontally as well as vertically. Thus one finds Bach utilizing form as he does harmony and melody in counterpoint at a completely new level. When one divides vertically between subject entrances and episodes, one notices that the entrances of the subject, which now act as a ritornello or refrain, are 16 measures long and the episodic verses are 15 measures long. This is illustrated in FIGS. 7 and 8.

A benefit of this new analytical approach, while preparing for a performance of a work such as this, lies in the ability to phrase related melodies (in a given composition) equally to each other, independently of all others, thus giving the performance a depth and variety of musical colors, dynamics and articulation by establishing a clear thematic hierarchy. In other words, each color in this fugue (as shown in FIG. 2) should have its own personal identity, phrasing, articulation, shape and direction, although not necessarily in the same dynamic range. Rarely does one hear performances that depict the rich variety of techniques utilized by Bach.

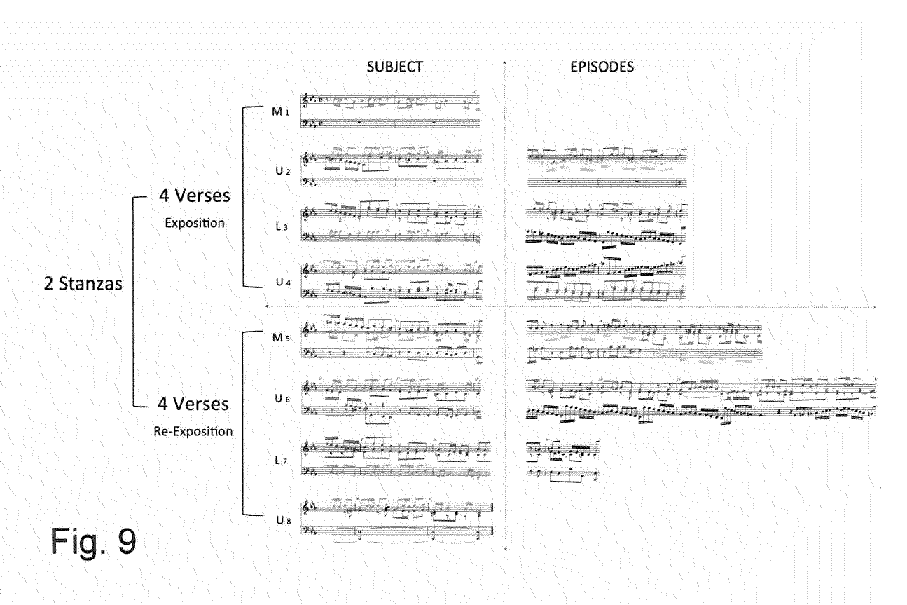

Each color may be orchestrated as the same instrument (or group of instruments) and different colors as different instruments (or stops if using an organ); or on the piano by changing character between subject entrances and episodes, polarizing the sections. When deciding what phrasing to choose, one may wish to make sure it is possible to maintain the same identical phrasing and articulation throughout the piece for each color, especially in intricate passages. This is shown, for example, in FIG. 9. Most musicians commonly settle for knowing where the entrances of the subject are, and that by no means is enough to do justice to these miniature masterpieces.

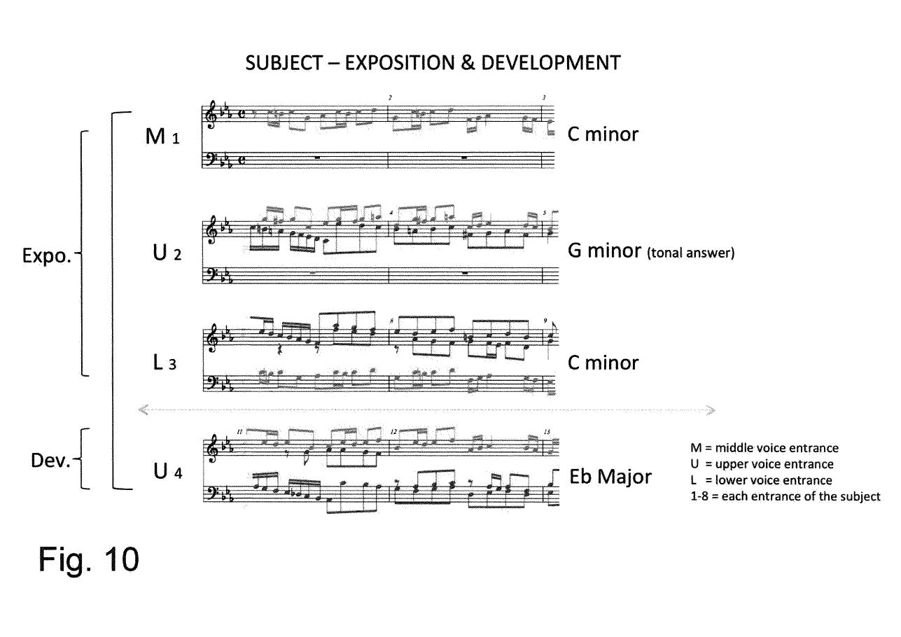

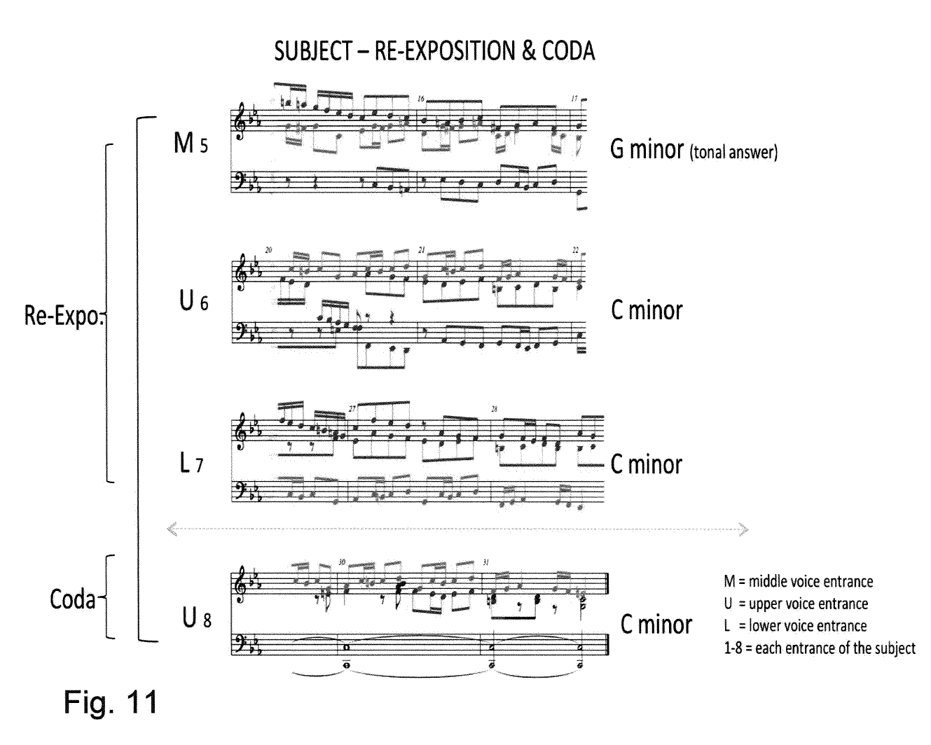

Looking at the exposition by itself (FIG. 10), one can see that the first three entrances of the subject represent the thematic exposition of the subject and its two complementary counter-subjects (green and blue), and the fourth statement represents the development section in the key of E-flat. In the example, each system is labeled with numbers 1 through 8 and letters MULU (Middle=alto entrance of the subject, Upper=soprano, Lower=tenor) and in FIG. 11 the same pattern is taken up identically in the re-exposition (MULU), however now the last statement Us represents the coda.

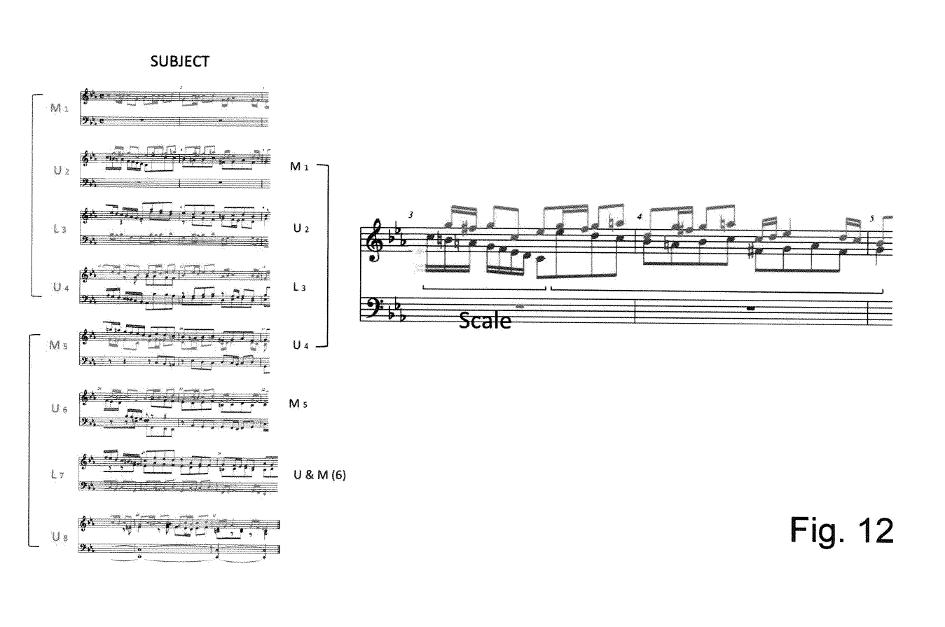

The first counter subject (represented in green in FIG. 12) is mainly constructed of stepwise motion to counteract the angular nature of the subject. Counter subject 1 also mimics or imitates the pattern (MULU) of the ordered entrances of the subject utilizing a canonic technique.

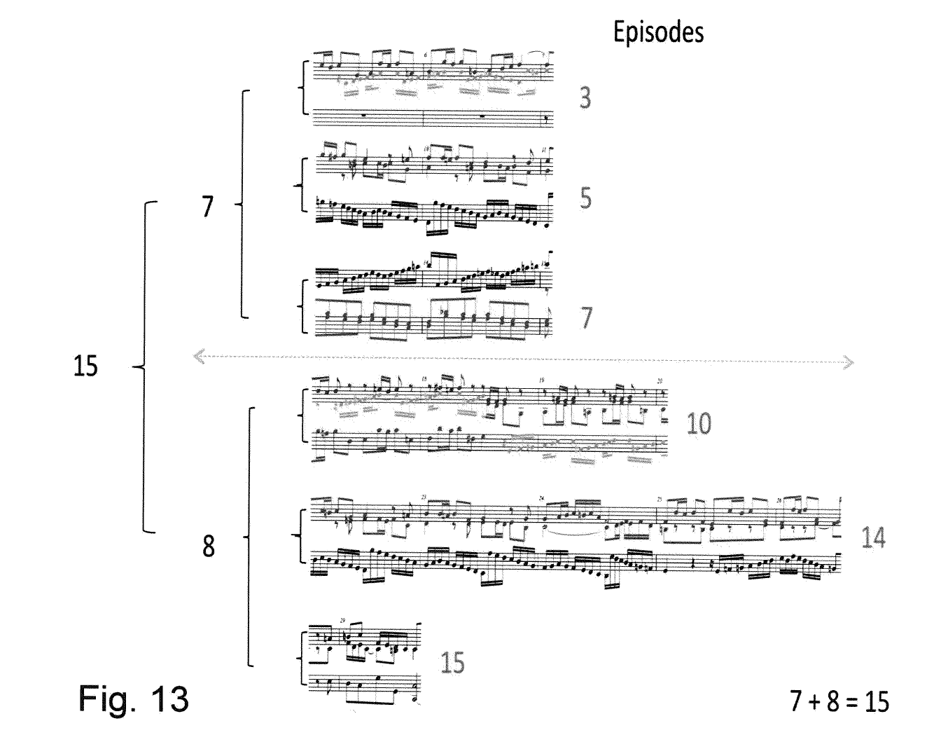

FIG. 13 illustrates an analysis of the episodes by themselves. Note that on the left (in black) is shown the mathematical proportion and on the right (in red) measure numbers starting from one. The episodes make use of the rich materials from the subject and countersubjects while they build up tension and drama and explore new harmonies and dissonances. By portraying the architecture of music in accordance with this new method, one notices that perhaps their most climactic effect lies in the delay of the return of the subject as in measure 14 in FIG. 13.

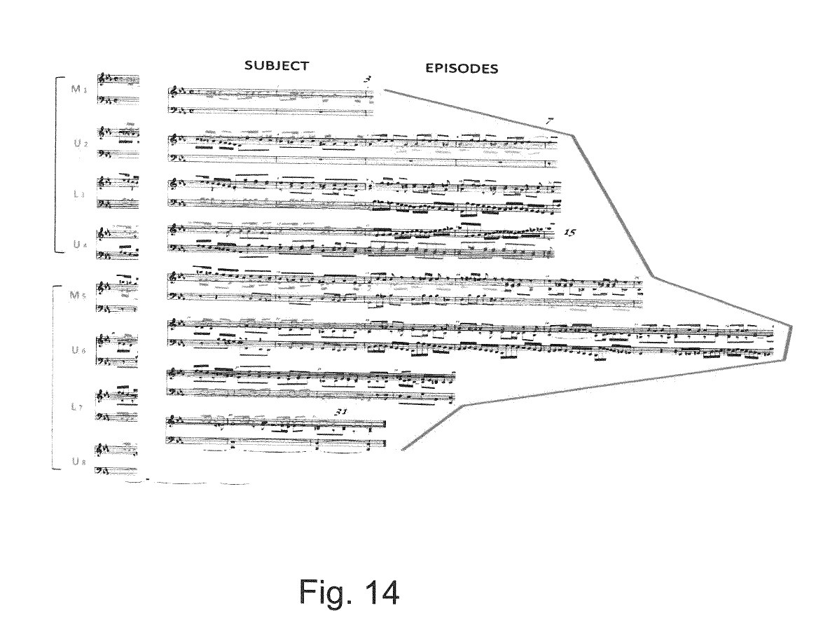

When one turns the entire composition on its side after having organized the music into blocks of phrases, as illustrated in FIG. 14, one can clearly see the dramatic arch, as a skyline view where the higher one goes the more tension in the piece, harmonically and dramatically.

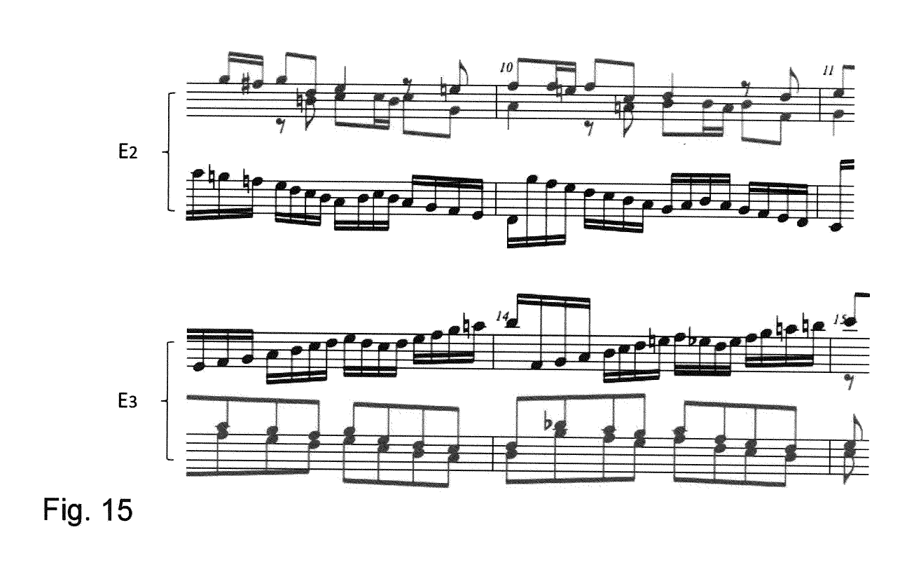

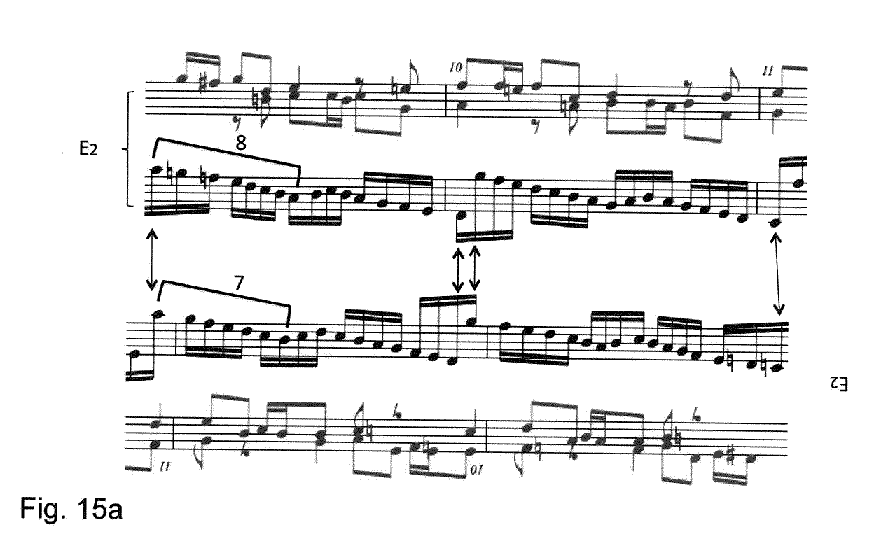

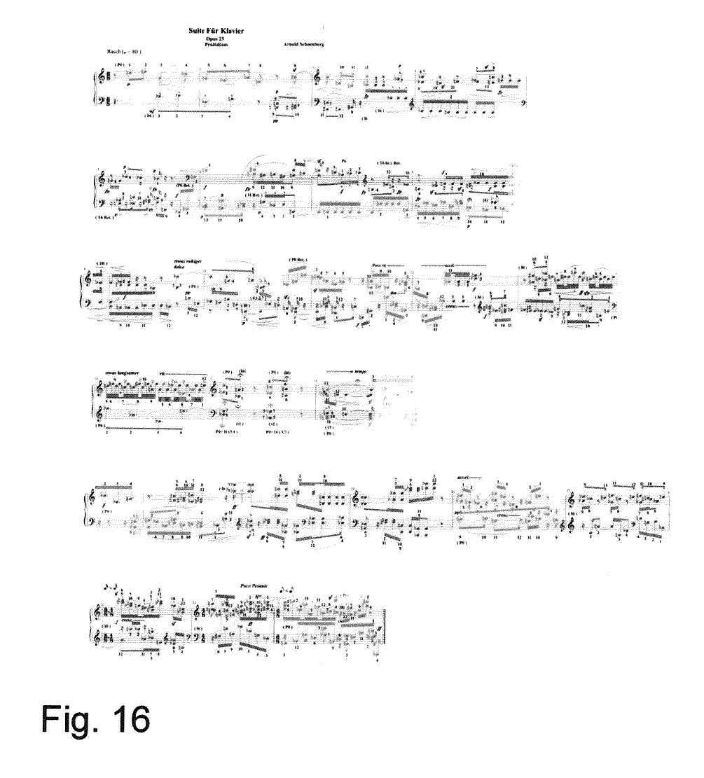

When comparing episodes two and three (E₂ and E₃) in FIG. 15, one can see with ease that the scales represented in black depict a perfect inversion—each is a mirror image of the other. Furthermore, the mastery of Bach's command of music can be seen in FIG. 15a; here one can see the second episode (E2) now upside down where a retrograde almost worked perfectly. Though a perfect retrograde did not work in this instance, since it is one note short (seven vs. eight notes), the contour of high notes to low notes is perfect. All of these great details clearly come to light in this new layout as a reflection of the architectural design intended by the composer. FIG. 16 shows Schoenberg's Piano Suite op. 25, Prelude.

When one applies the same analytical method to the Prelude of Schoenberg's Suite op. 25 (FIG. 16) one realizes that although it is titled prelude, in reality it is a four voice fugal structure based on serial technique (12-tone). The beauty of the symmetrical mathematical structure lies not only in the melodic and harmonic reciprocity expressed on Schoenberg's matrix but in the thematic mastery of palindromes, juxtapositions, inversions, retrograde, overlapping, interlocking and many more techniques that consist of 12 notes only.

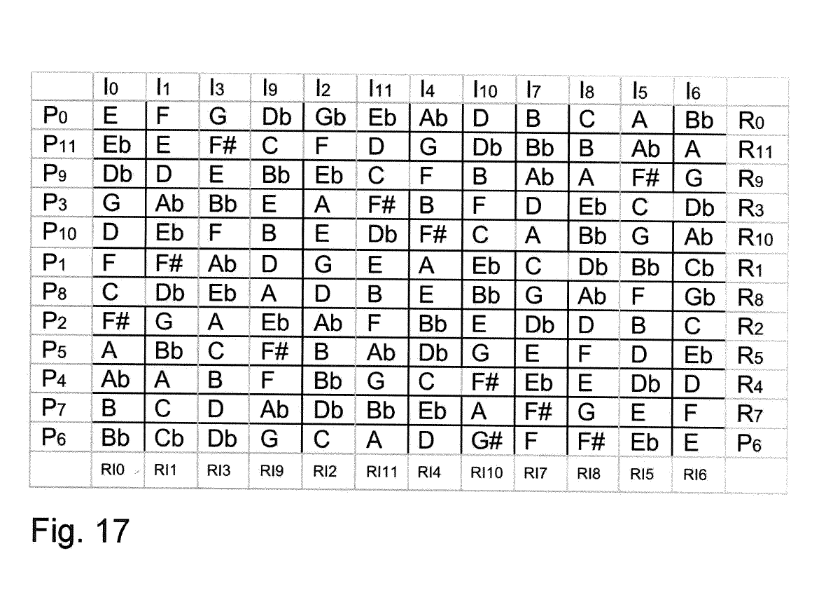

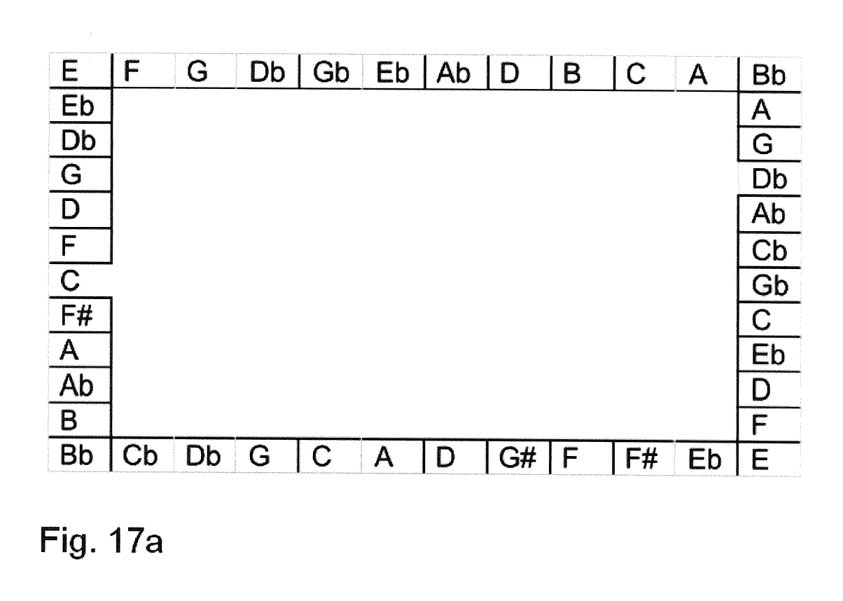

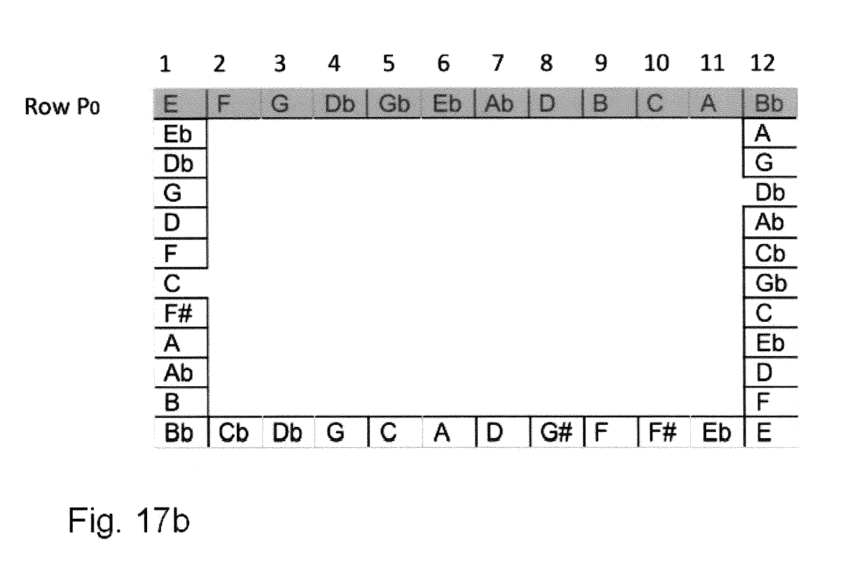

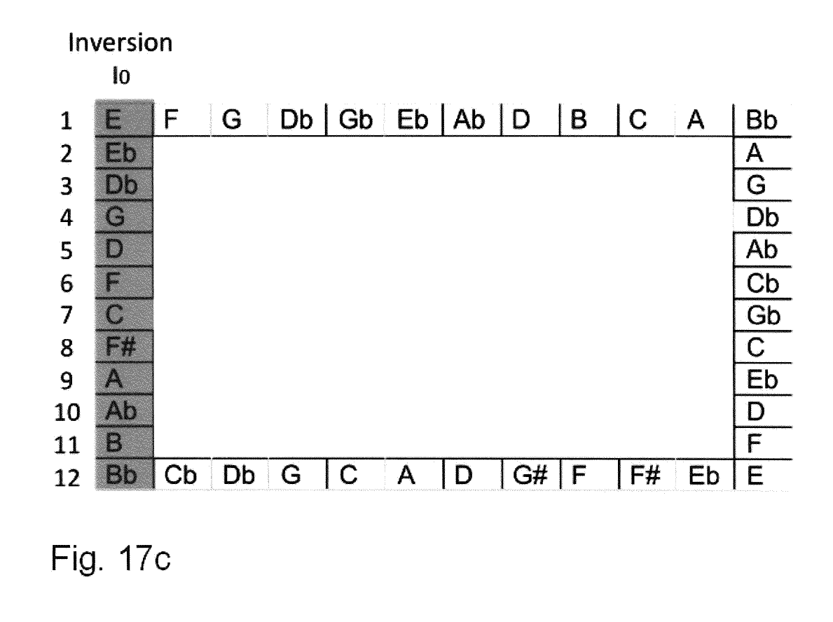

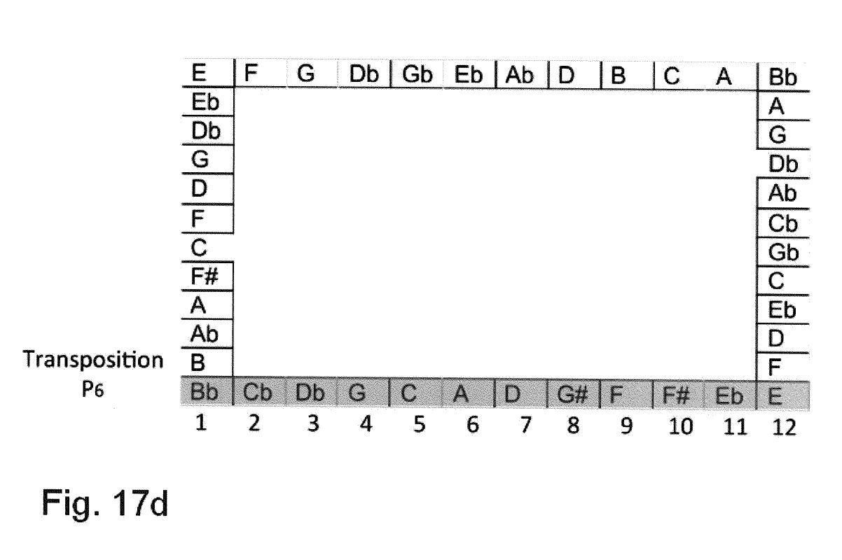

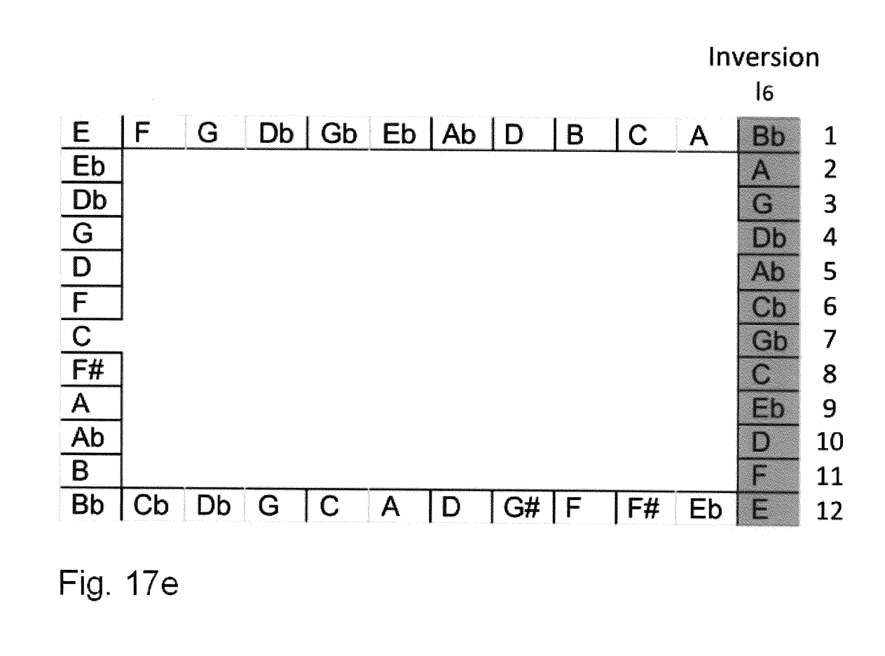

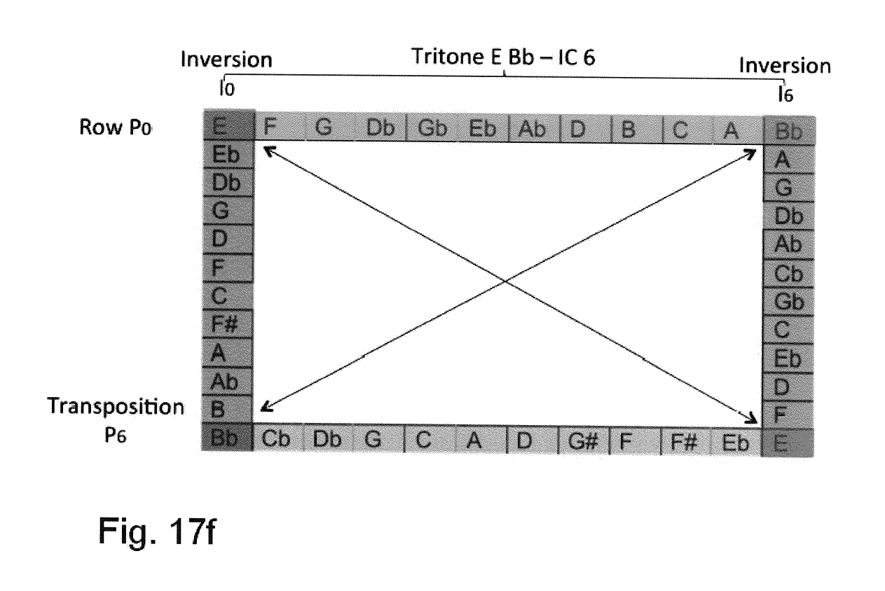

FIG. 17 shows the Matrix for the entire suite, which Schoenberg used as the base mathematical structure; however the focus here is only on the prelude, which uses the outside edge of the Matrix only. Red in the score as well as the matrix represents the original set (P₀), the most important 12 note row on which the entire suite is based. In blue one has inversion zero (I₀), in brown transposition sum six (P₆) and in green inversion six (I₆); all of which Schoenberg exploits in retrograde, particularly at the tetrachord level.

In FIG. 17f, one can notice the tritone polarity of the matrix—E to Bb—in which interval class six is used as the “Dominant” since it is the halfway point in serial technique.

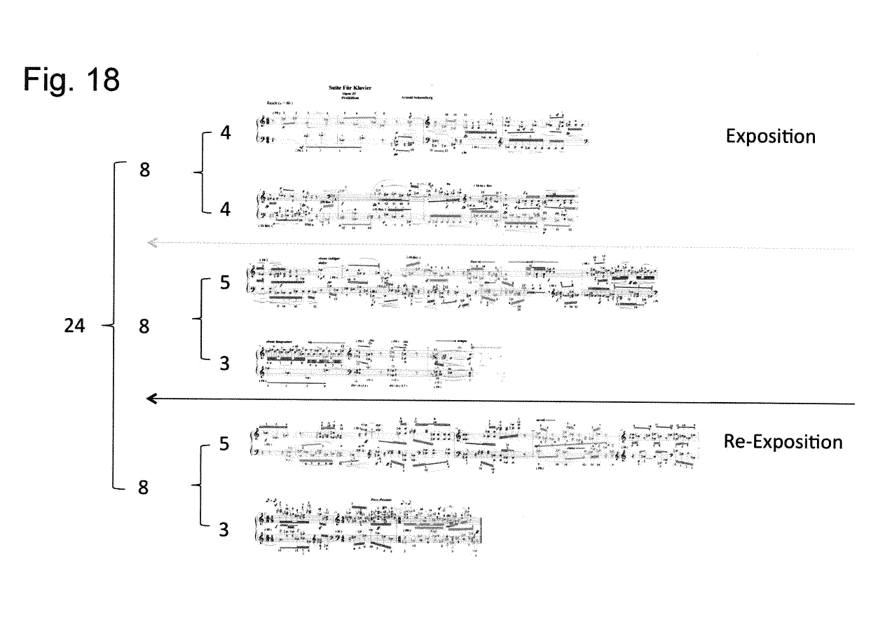

Regarding the form and architectural design of this prelude, FIG. 18 depicts three groups or sections made up of eight bar phrases where the first section is divided equally in half (4+4) and the second and third sections in Golden proportion (5+3). Thematically speaking, from a fugal perspective, there is a clear exposition and re-exposition treated in a very modernist way. A relevant question remains: Why this particular layout? Why divide the work like this since clearly there is not a melodic restatement of the main subject P₀ (red) as in the example by Bach?

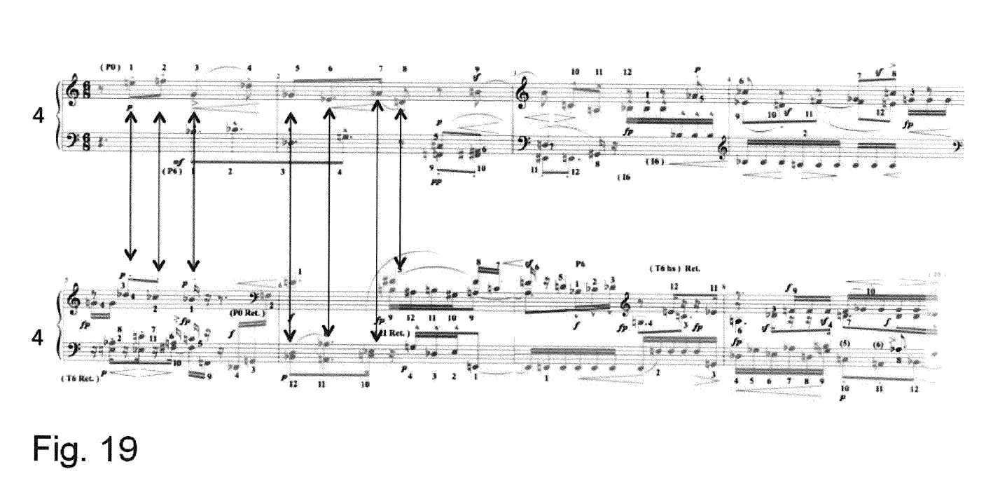

Using the method of the present invention, referring to FIG. 19, one finds the answer: rhythm takes precedence over melody. The rhythmic restatement of the subject in the second system is a transformation, presented in a retrograde inversion at the tetrachord level (T₆), as shown in brown.

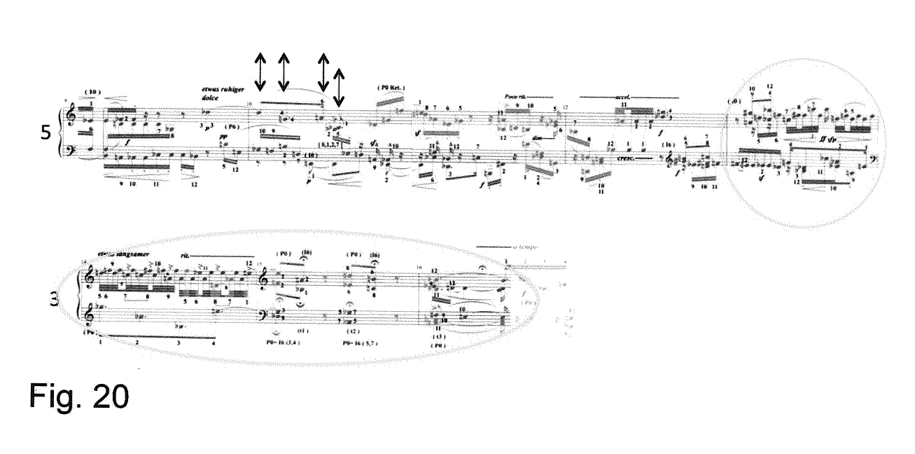

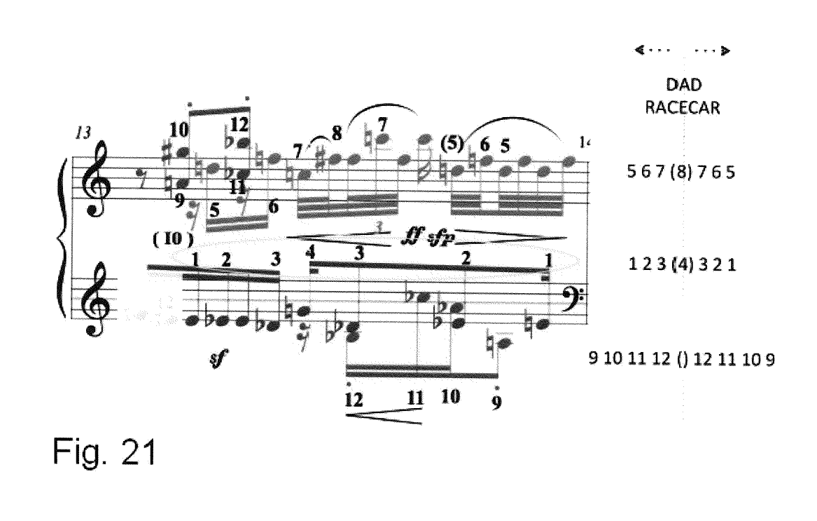

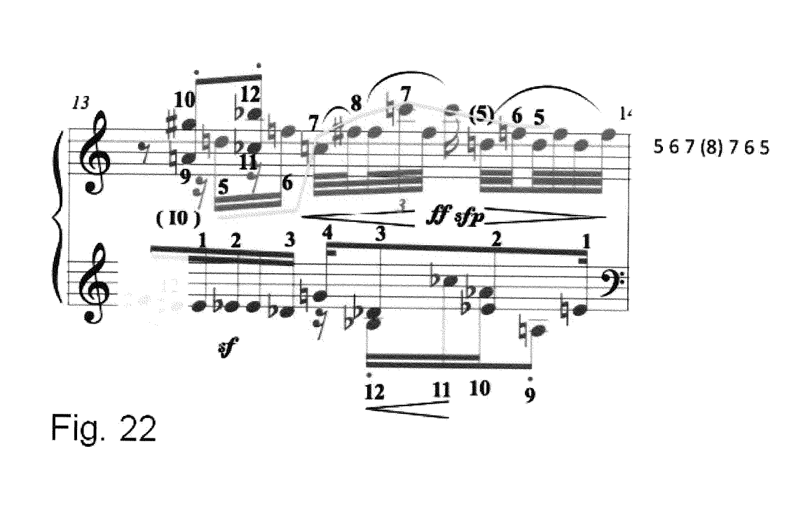

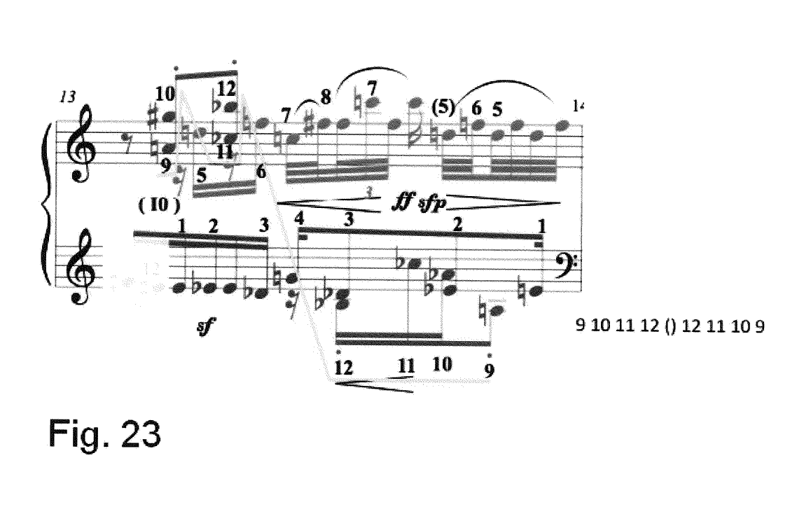

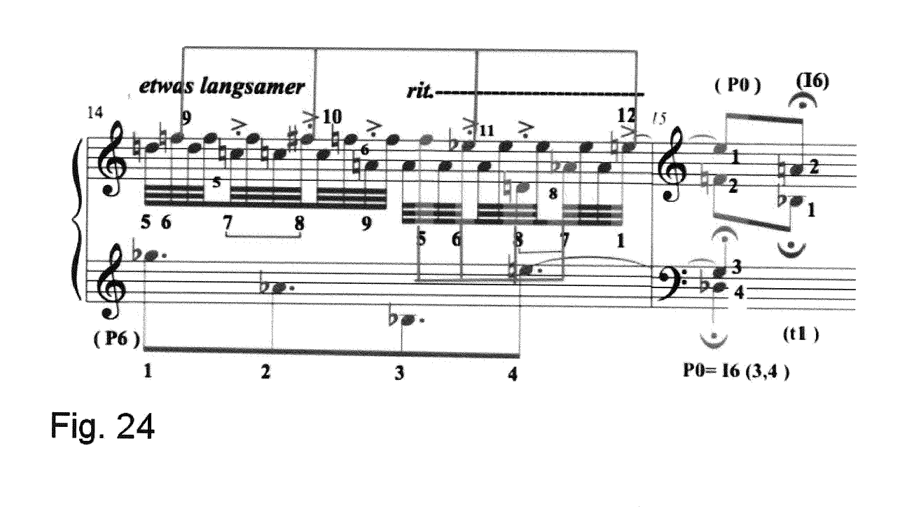

In the second section (FIG. 20), Schoenberg utilizes two new techniques, the use of palindromes in measure 13 and voice overlapping in measure 14. Looking at measure 13 in detail (FIG. 21), one finds three overlapping palindromes, where the easiest to see is represented in green as 1 2 3 4 3 2 1, followed by (FIG. 22) 5 6 7 8 7 6 5 in red and (FIG. 23) 9 10 11 12 12 11 10 9 in purple. The overlapping technique in measure 14 (FIG. 24) at the tetrachord level is an ingenious use of accents and common notes by Schoenberg.

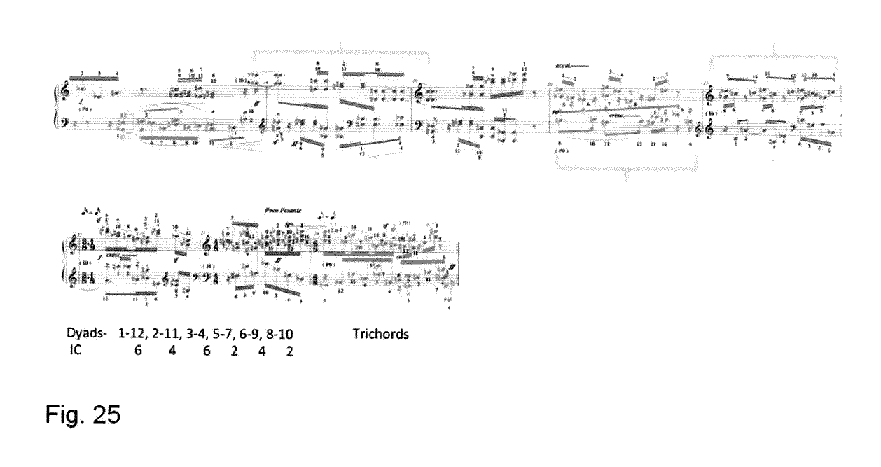

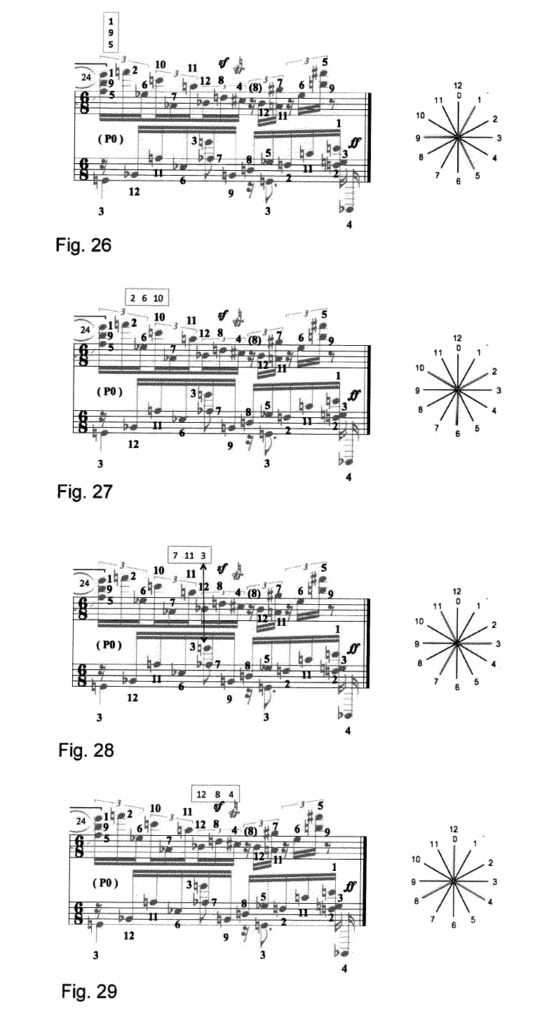

Section three acts as the re-exposition (FIG. 25) which deals with palindromes, and complete presentations of each voice in this fugal structure. The second system represents a three-measure long coda focusing on dyads and trichords. FIGS. 26-29 display a new mathematical principle of construction in which four trichords of the set are proportionally built using the Clock Wheel. The first trichord is 1 9 5 (FIG. 26), the second trichord is 2 6 10 (FIG. 27), the third is 7 11 3 (FIG. 28), and the fourth is 12 8 4 (FIG. 29).

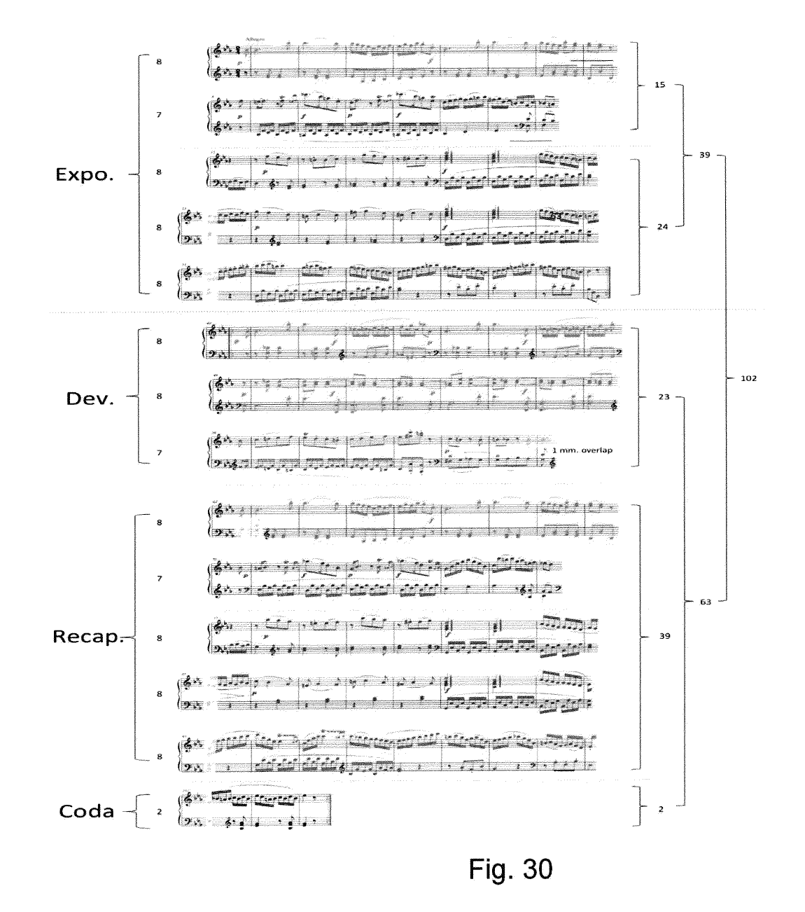

Lastly, one can apply this method to sonata allegro form. FIG. 30 displays the entire third movement (102 measures long) of Mozart's Piano Sonata No. 4 in E-flat major, K. 282. Notice that everything is aligned and that every phrase (verse/system) is 8 measures long except for the three instances of the 7 measure long phrase and the 2 measure coda (codetta). No indication of the meaning of those seven bar phrases has been found in historic or academic texts to provide a satisfying explanation for them. Such phrases commonly occur in Mozart, Haydn, Beethoven, and Schubert's works, and these so called “irregular phrases” are characteristically present in sonata form movements (along with other “irregular” phrase lengths).

The answer to the riddle of the seven bar phrase lies not only in the overall design of the piece, but also in the small details of each section: “One thing arises from all things, and all things arise from one thing”—Heraclitus. Taking the common understanding of an “irregular phrase,” there is a risk of communicating and reinforcing a misconception. In other words, one does not consider any of the traditionally called irregular phrases in the examples of Bach, Mozart and Schoenberg to fall under the category of an “irregular” phrase. Every single phrase examined herein is proportional, symmetrical, organized, acting in accord and following the prescribed procedures of the overall architectural design of the work. As a result of the organization of phrases and the discovery of hidden mathematical proportions in the proposed method, one would consider these phrases to have an irregular meter as in poetic analysis but they would not be considered to be irregular.

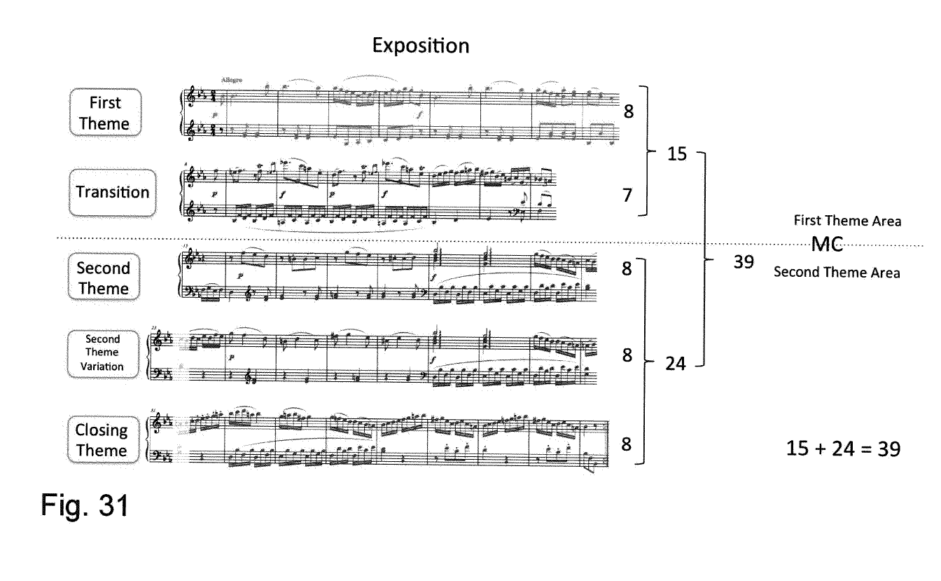

In the exposition (FIG. 31), the seven measure long phrase (the transition) occurs in order to allow the large-scale architectural design of the piece to exist. This “phrase of irregular meter” is not arbitrarily created, but is part of the greater poetic and formal scheme of the work. Note that the dotted line represents the medial caesura that separates the first theme area from the second.

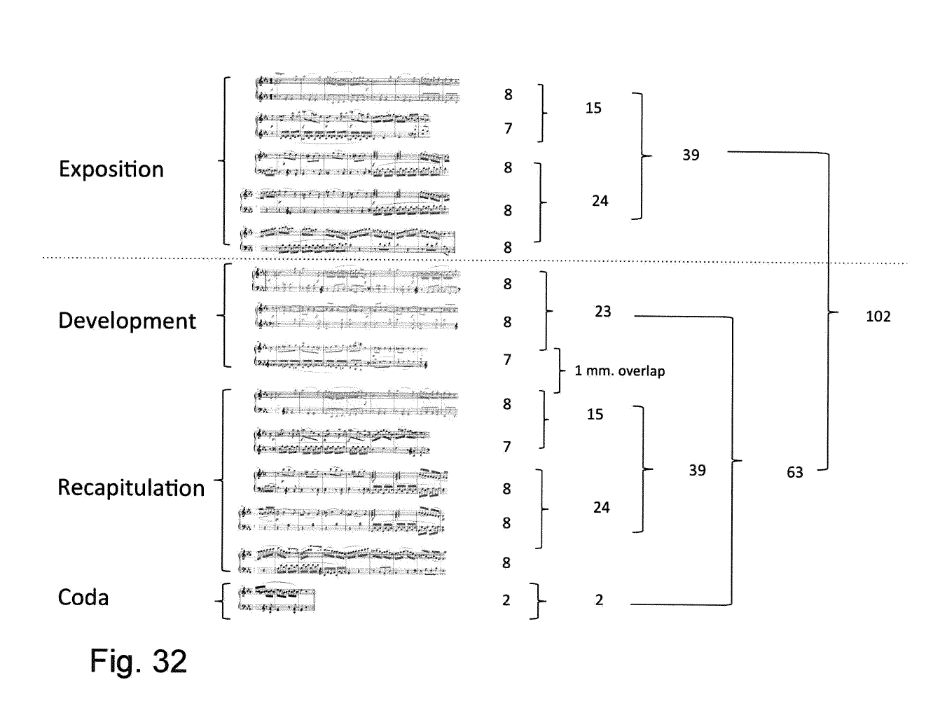

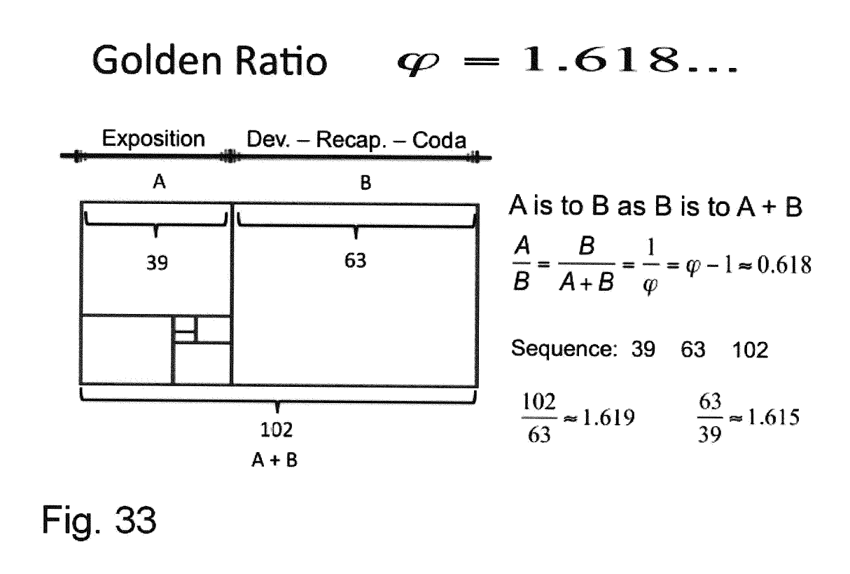

In FIG. 32, one sees a clear mathematical proportion emerges to clarify the division of themes and phrases. The first theme area is 15 measures long and the second theme area is 24 measures long; adding 15+24=39 and 39 (expo)+63 (development/recap/coda)=102. At this point one can no longer avoid the presence of the Golden Proportion (also called the golden mean, golden section, golden ratio, golden cut or divine proportion), which is perhaps the most optimal way of combining binary and ternary form. The numbers that provide the best approximation to the Golden Ratio can be examined in FIG. 33. The Golden Ratio in musical terms states that the exposition is to the development/recap/coda as the development/recap/coda is to the entire movement (the total sum of the exposition/development/recap/coda).

Once music is organized in a coherent phrase structure according to the present invention, the form reveals itself. In addition to presenting a practical and holistic method of portraying a score, the invention provides a deeper structural understanding of the composition, which makes the themes and underpinnings apparent to the performer. What used to take years or decades of analysis can now be more easily seen from the onset. This new platform could become indispensable for performers and educators, as the form reveals itself. This leaves one excited about the possibility of exploring the fascinating tools employed by the most brilliant minds in the world of music.

Music as an artistic expression is able to communicate the relationship between poetry, architecture and musical design with ease, and mathematics helps us prove these relationships, while clarifying the meaning of seemingly unexplainable musical ideas such as the meaning of irregular phrases and intricate overlapping techniques.

All are encouraged to explore this new perspective for its cognitive advantages, especially in regards to visual memory and a deeper understanding of the meaning of music. From a visual perspective, the present invention serves as a roadmap to understanding the meaning of “The Architectural Design of Musical Form.”

The present invention may be embodied or employed as an editing program (software/app/plugin) that can process what the new digital editions of this method demand. For these new editions to be mass-produced, software (and possibly hardware) intelligent enough to analyze the musical score will be necessary. A team of musicians and skilled computer programmers can set the parameters of the new method.

Users of the editing software may include, but are not limited to, composers, arrangers, transcribers, copyists, (theorists) theory majors, musicians in general, someone capable of reading and writing music notation.

Digital editions can be developed that will act as an interactive learning tool. With the present method as its core, a responsive digital edition can be created that would allow users to determine what they wish to learn about any given work, including but not limited to harmonic, melodic, rhythmic and structural aspects of a musical composition. Target audiences for the digital editions can include, but are not limited to, performers of every level, educators, students of all ages, musicians in general, mathematicians, amateurs, music lovers, etc.

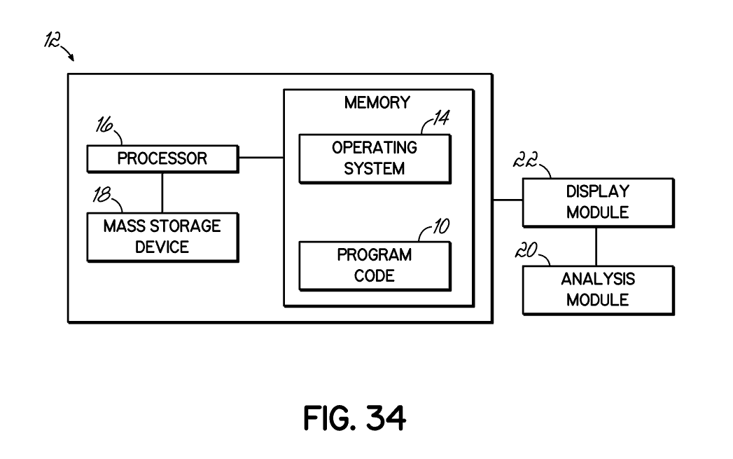

With reference to FIG. 34, embodiments of the invention may be embodied as a method, a computer program product that includes program code 10 to execute the method, and/or a computer system 12 configured to execute the method. The method includes the steps described herein and illustrated in FIGS. 2 to 33 for analyzing and displaying musical scores.

The program code 10 includes instructions executable on a computer system 12 for carrying out the steps of the method. In one embodiment, the program code 10 includes instructions for analyzing and displaying musical scores. Embodiments of the invention, whether implemented as part of an operating system 14, application, component, program code 10, object, module or sequence of instructions executed by one or more processing units 16 are referred to herein as “program code.” The program code 10 typically comprises one or more instructions that are resident at various times in various memory and storage devices 18 in the computer system 12 that, when read and executed by one or more processors 16 thereof cause that computer system 12 to perform the steps necessary to execute the instructions embodied in the program code 10 embodying the various aspects of the invention.

While embodiments of the invention are described in the context of fully functioning computing systems 12, those skilled in the art will appreciate that the various embodiments of the invention are capable of being distributed as a program product on a computer readable storage medium. The program product may embody a variety of forms. The invention applies equally regardless of the particular type of computer readable storage medium used to actually carry out the distribution of the program code 10. Examples of appropriate computer readable storage media for the program product include, but are not limited to, non-transitory recordable type media such as volatile and nonvolatile memory devices, floppy and other removable disks, hard disk drives, USB drives, optical disks (e.g. CD-ROM's, DVD's, Blu-Ray discs, etc.), among others.

Any of the individual processes described above or illustrated in FIGS. 2-33 may be formed into routines, procedures, methods, modules, objects, and the like, as is well known in the art. It should be appreciated that embodiments of the invention are not limited to the specific organization and allocation of program functionality described herein.

In addition, the systems for analyzing and displaying musical scores may further include a module for analyzing the musical score data (i.e. a musical score data analyzer) 20 and a module for displaying musical score data 22. The musical score data analyzer module may include a system of capturing musical score data prior to analysis, such as a scanner capable of scanning the musical data or an input system, such as a keyboard or other such device. Musical score data analyzer modules as known in the art may be used in accordance with the invention. The musical score data analyzer module includes components and/or program code to receive and then display analyzed musical score data from the musical score data analyzer.

While example embodiments of the present invention have been described in detail, it should be apparent that modifications and variations thereto are possible, all of which fall within the true spirit and scope of the invention. Therefore, the foregoing is intended only to be illustrative of the principles of the invention. Further, since numerous modifications and changes will readily occur to those skilled in the art, it is not intended to limit the invention to the exact construction and operation shown and described. Accordingly, all suitable modifications and equivalents may be included and considered to fall within the scope of the invention.

What I claim is:

1. A method of organizing segments of a musical composition comprising:
identifying more than one block of material within the musical composition;
presenting each block in a linear fashion on a display template, with each such presented block located in a distinct space on the display template; and
organizing the presented blocks on the display template in a reproducible order.

2. The method of claim 1 wherein each block is presented, one above the other.

3. The method of claim 1 wherein each block is presented adjacent the other.

4. The method of claim 2 wherein measures within each block are dimensioned so that single measures in each block align one above the other.

5. The method of claim 1 wherein each block is assigned a distinct color.

6. The method of claim 4 wherein the organized blocks comprise an interactive score.

7. The method of claim 6 wherein the interactive score comprises one or more of a digital edition, software, and an interactive PDF.

8. The method of claim 1 wherein each block of material comprises a phrase.

9. The method of claim 8 wherein a number of measures for a block is determined by the phrase.

10. The method of claim 9 wherein the phrase follows rules of harmonic structure intended by a composer of the musical composition.

11. The method of claim 9 wherein the phrase follows rules of rhythmic structure intended by a composer of the musical composition.

12. The method of claim 10 wherein a distinct color is assigned to a related pattern of the harmonic structure.

13. The method of claim 11 wherein a distinct color is assigned to a related pattern of the rhythmic structure.

14. The method of claim 1 wherein each block is labeled as a formal structure.

15. The method of claim 1 wherein all segments of the musical composition are displayed on the display template.

16. A visual layout of a musical score comprising:
more than one block of material selected from the musical score, each block arranged on a display template in a linear fashion in a distinct space on the display template.

17. The musical layout of claim 15 wherein each block of material is displayed one above the other.

18. The visual layout of claim 17 wherein single measures in each block align one above the other.

19. The visual layout of claim 16 wherein each block is depicted in a distinct color.
